(19) United States
(12) Patent Application Publication
(10) Pub. No.: US 2015/0120771 A1
(43) Pub. Date: Apr. 30, 2015

(54) METHOD FOR PROCESSING DATA AND ELECTRONIC DEVICE THEREOF

(71) Applicant: SAMSUNG ELECTRONICS CO., LTD., Suwon-si (KR)

(72) Inventors: Hyo-Seong LEE, Yongin-si (KR); Yong-Geon KIM, Daejeon (KR)

(21) Appl. No.: 14/513,758

(22) Filed: Oct. 14, 2014

(30) Foreign Application Priority Data
Oct. 31, 2013 (KR) 10-2013-0131701

(51) Int. Cl. G06F 17/30; H04L 29/08; H04L 29/06

(52) U.S. Cl. CPC G06F 17/30386; H04L 67/42; H04L 67/30; G06F 17/30117
USPC 707/758; 709/203

(57) ABSTRACT

A method for processing data of an electronic device is provided. The method includes confirming two or more data groups having a group relation similarity, the two or more data groups being conformed from a plurality of data groups each including information of one or more users. Further, the method includes transmitting the confirmed two or more data groups to another electronic device, and deleting the two or more data groups transmitted to the other electronic device from the electronic device.

### CROSS-REFERENCE TO RELATED APPLICATION(S)

This application claims the benefit under 35 U.S.C. §119(a) of a Korean patent application filed in the Korean Intellectual Property Office on Oct. 31, 2013 and assigned Serial number 10-2013-0131701, the entire disclosure of which is hereby incorporated by reference.

### TECHNICAL FIELD

The present disclosure relates to a method for processing data and an electronic device thereof.

### BACKGROUND

Data of a Social Network Service (SNS) occurs between people having relations, that is, between users who have social relations. That is, a platform of combining a basic life principle that users having relations give and take data between them with a technology and dividing user data based on relations to provide a service is being established.

An electronic device uses a sharding technique of dividing data and providing a service using a plurality of databases in processing high capacity data. However, in a case of inquiring into data dispersed in a plurality of shards, an issue for merge, classification, and integration occurs.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below.

Since related art simply partitions and discriminates (shards) data using a simple condition such as regional data, a number, an alphabet spelling, year, a country, a hash code, it is difficult to apply the related art to complicated user information such as a social service, etc. For example, in a case of dividing data for each country, when the data is divided and processed for each country, most of users communicate with people of the same country, so that it is effective. However, in a case of a large country such as China or India, a limitation is encountered and it is difficult to guarantee that users always communicate with people of the same country.

In a case of a social service, etc. based on relation, relation data is generated between people where a social relation is formed. Even in a case of a system where relation type data occurs mostly, relation data may be discriminated based on relation information so that data that extends infinitely may be processed.

In accordance with an aspect of the present disclosure, a method for processing data of an electronic device is provided. The method includes confirming two or more data groups having a group relation similarity, the two or more data groups being confirmed from a plurality of data groups each including information of one or more users, and transmitting the confirmed two or more data groups to another electronic device, and deleting the two or more data groups transmitted to the other electronic device from the electronic device.

In accordance with another aspect of the method of the present disclosure, each data group of the plurality of data groups performs obtaining information of a plurality of users, obtaining one or more consumption information included in each of the information of the plurality of users, determining relation similarity of the information of the users based on the one or more consumption information, and when the information of the users has the relation similarity, storing the information of the users in a same data group to generate the data group.

In accordance with another aspect of the present disclosure, an electronic device is provided. The electronic device includes a communication interface configured to communicate with another electronic device, a memory including information of one or more users, and a processor configured to confirm two or more data groups having a group relation similarity, the two or more groups being confirmed from a plurality of data groups each including the information of the one or more users, and to transmit the confirmed two or more data groups to the other electronic device and delete the two or more data groups transmitted to the other electronic device from the electronic device.

In accordance with another aspect of the present disclosure, the processor is further configured to obtain information of a plurality of users with respect to each of the plurality of data groups, to obtain one or more consumption information included in each of the information of the plurality of users, to determine relation similarity of the information of the users based on the one or more consumption information, and to, when the information of the users has the relation similarity, store the information of the users in a same data group to generate the data group.

In accordance with another aspect of the present disclosure a non-transitory computer-readable storage medium is provided. The non-transitory computer-readable recording medium storing instructions that, when executed, cause at least one processor to perform a method including confirming two or more data groups having a group relation similarity, the two or more data groups being confirmed from a plurality of data groups each comprising information of one or more users, and transmitting the confirmed two or more data groups to another electronic device, and deleting the two or more data groups transmitted to the other electronic device from the electronic device.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device according to an embodiment of the present disclosure;

FIG. 2 is a block diagram illustrating an operation processing module in an electronic device according to an embodiment of the present disclosure;

FIGS. 3A and 3B are views illustrating an operation of relating one or more data in an electronic device according to various embodiments of the present disclosure;

FIGS. 4A and 4B are views illustrating an operation of relating one or more data in an electronic device according to various embodiments of the present disclosure;

FIGS. 5A and 5B are views illustrating an operation of relating one or more data in an electronic device according to various embodiments of the present disclosure;

FIG. 6 is a flowchart illustrating an operation of relating one or more data in an electronic device according to an embodiment of the present disclosure;

FIG. 7 is a flowchart illustrating an operation of relating one or more data in an electronic device according to an embodiment of the present disclosure; and

FIG. 8 is a block diagram illustrating hardware according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions are omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Expressions of “include”, “may include” that may be used for various embodiments of the present disclosure indicate existence of disclosed relevant function, operation, elements, etc. and do not limit additional one or more functions, operations, elements, etc. Also, terminologies such as “include” or “have” in various embodiments of the present disclosure are intended for designating existence of a characteristic, a number, step, operation, an element, a part, or a combination of these described in the specification, and should not be construed as excluding in advance existence of one or more other characteristics, numbers, steps, operations, elements, parts, or a combination of these, or possibility of addition.

An electronic device according to various embodiments of the present disclosure may be a device including a communication function. For example, the electronic device may include a smartphone, a tablet Personal Computer (PC), a mobile phone, a video phone, an electronic book reader, a desktop PC, a laptop PC, a netbook computer, a Personal Digital Assistant (PDA), a Portable Multimedia Player (PMP), an MP3 player, a mobile medical device, a camera, and a wearable device (e.g., at least one of a Head-Mounted Display (HMD) such as an electronic glasses, electronic clothes, an electronic bracelet, an electronic necklace, an electronic appcessory, and a smart watch).

According to a certain embodiment, an electronic device may be a smart home appliance having a communication function. The smart home appliance may include, for example, at least one of a television (TV), a Digital Versatile Disc (DVD) player, an audio player, a refrigerator, an air conditioner, a cleaner, an oven, an electronic range, a washing machine, an air purifier, a set-top box, a TV box (for example, Samsung HomeSync™, Apple TV™, or Google TV™), a game console, an electronic dictionary, an electronic key, a camcorder, and an electronic frame.

According to a certain embodiment, the electronic device may include at least one of various medical devices (e.g., a Magnetic Resonance Angiogram (MRA) device, a Magnetic Resonance Imaging (MRI) device, a Computed Tomography (CT) device, a shooting device, an ultraviolet device, etc.), a navigation device, a Global Positioning System (GPS) receiver, an Event Data Recorder (EDR), a Flight Data Recorder (FDR), an automobile infotainment device, an electronic equipment for ship (e.g., a navigation device for ship, a gyro compass, etc.), an aviation electronic device, and a security device.

According to a certain embodiment, an electronic device may include at least one of a furniture or a portion of a building/structure including a communication function, an electronic board, an electronic sign input unit, a projector, and various measurement devices (e.g., waterworks, electricity, or radio waves, etc.). An electronic device according to various embodiments of the present disclosure may be a combination of one or more of the above-mentioned devices. Also, it is obvious to a person of ordinary skill in the art that an electronic device according to various embodiments of the present disclosure is not limited to the above-mentioned devices. Hereinafter, an electronic device according to various embodiments of the present disclosure is described with reference to the accompanying drawings. A terminology of a user used for various embodiments may denote a person who uses an electronic device or a device (e.g., an artificial intelligence electronic device) that uses the electronic device.

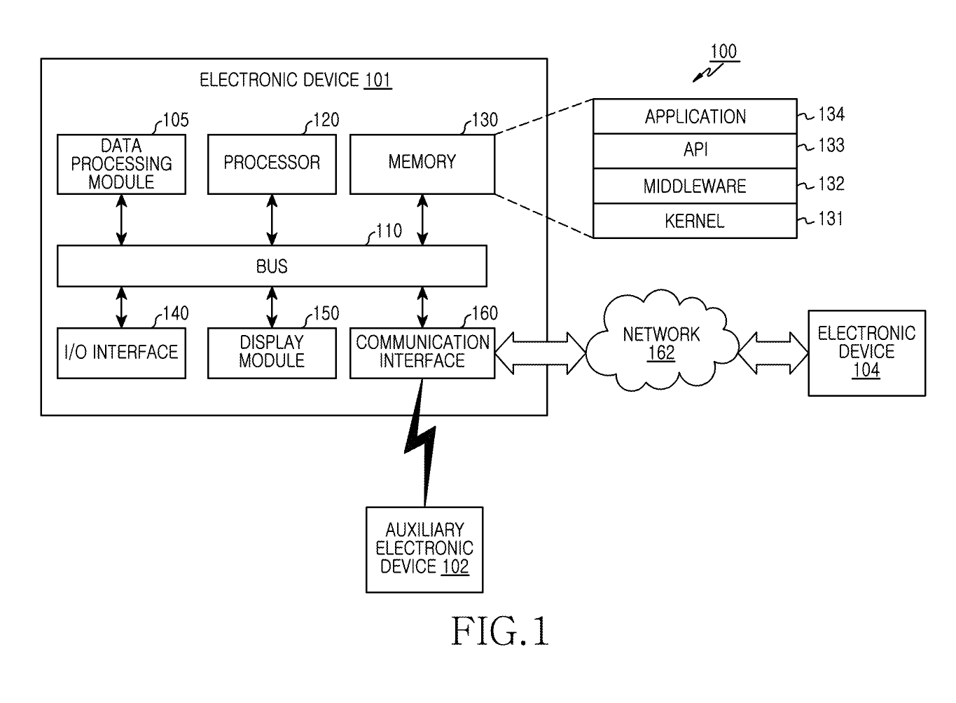

FIGS. 1 through 8, discussed below, and the various embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the present disclosure. Terms first, second, and the like are used to differentiate between objects having the same terminology and are in no way intended to represent a chronological order, unless where explicitly stated otherwise. A set is defined as a non-empty set including at least one element.

FIG. 1 is a block diagram illustrating an electronic device 101 according to an embodiment of the present disclosure.

Referring to FIG. 1, a block diagram 100 is illustrated, wherein the block diagram 100 includes an electronic device 101 that may include a data processing module 105, a bus 110, a processor 120, a memory 130, an Input/Output (I/O) interface 140, a display module 150, and/or a communication interface 160.

The data processing module 105 may process to detect that data corresponding to a new user accesses user data of the electronic device 101. The data processing module 105 may process to detect data for a user profile (or user's information) not registered in a database of the electronic device 101 or a user profile registered in the database in detecting a new user accesses. The data processing module 105 may control to detect comparison group data for obtaining sameness similarity of a data group (e.g., shard) forming a database from a user profile. Here, the shard may be defined as one data set processed according to a sharding technique that processes data in a database. The data processing module 105 may compare sameness or similarity relation between information corresponding to data detected from a user profile or a data group included in a database, and control to obtain information regarding a data group whose sameness and similarity with a user profile represent a designated numerical value or more. The data processing module 105 may control to provide one or more data groups forming a database and a data group (e.g., shard) that has sorted, distributed, and combined one or more user profiles included in a data group according to a method set at the electronic device 101. The data processing module 105 may generate a data group having a same or similar range based on a relation degree of one or more user profiles, and control to provide one or more connected data groups having a relation degree of a same or similar range. The data processing module 105 may provide to share a connected data group and a user profile included in the connected data group.

The bus 110 may be a circuit that connects the above-described elements with each other and transfers communication (e.g., a control message) between the above-described elements.

The processor 120 may, for example, receive an instruction from the above-described other elements (e.g., the memory 130, the I/O interface 140, the display module 150, the communication interface 160, etc.) via the bus 110 to decipher the received instruction, and execute an operation or a data processing corresponding to the deciphered instruction.

The memory 130 (e.g., the memory 125) may store an instruction or data received from the processor 120 or other elements (e.g., the I/O interface 140, the display module 150, the communication interface 160, etc.) or generated by the processor 120 or other elements. The memory 120 may include, for example, programming modules such as a kernel 131, a middleware 132, an application programming interface (API) 133, or an application 134, etc. Each programming module may be configured as software, firmware, hardware, or a combination of at least two or more of these.

The kernel 131 may control and manage system resources (e.g., the bus 110, the processor 120, or the memory 130, etc.) used for executing an operation or function implemented by the rest of other programming modules, for example, the middleware 132, the API 133, and the application 134. Also, the kernel 131 may provide an interface via which the middleware 132, the API 133, and the application 134 access an individual element of the electronic device 101 to control and manage the same.

The middleware 132 may perform a mediation role so that the API 133 or the application 134 may communicate with the kernel 131 to give and take data. Also, with regard to a task request received from the (plurality of) applications 134, the middleware 132 may perform load balancing for the task request using a method of assigning a priority that may use the system resource (e.g., the bus 110, the processor 120, or the memory 130, etc.) of the electronic device 101 to at least one of the (plurality of) applications 134.

The API 133 is an interface via which the application 134 may control a function provided by the kernel 131 or the middleware 132, and may include, for example, at least one interface or function for file control, window control, image processing, or character control, etc.

The I/O interface 140 may receive, for example, an instruction or data from a user and transfer the same to the processor 120 or the memory 130 via the bus 110. The display module 150 may display an image, video or data, etc. to a user. According to an embodiment, in a case where the display module 150 is provided in the form of a touchscreen panel, a user may input an instruction via a gesture of touching or hovering (e.g., an indirect touch input) the display module 150.

The communication interface 160 may connect communication between the electronic device 101 and an auxiliary electronic device 102 or an electronic device 104. The communication interface 160 may support predetermined short distance communication protocol on a network 162 (e.g., Wireless Fidelity (WiFi), BlueTooth (BT), Near Field Communication (NFC) or predetermined network communication (e.g., the Internet, Local Area Network (LAN), a Wide Area Network (WAN), a telecommunication network, a cellular network, a satellite network, or Plain Old Telephone Service (POTS), etc.)). Each of the electronic devices 102 and 104 may be the same (e.g., same type) as the electronic device 101 or a different (e.g., different type) device.

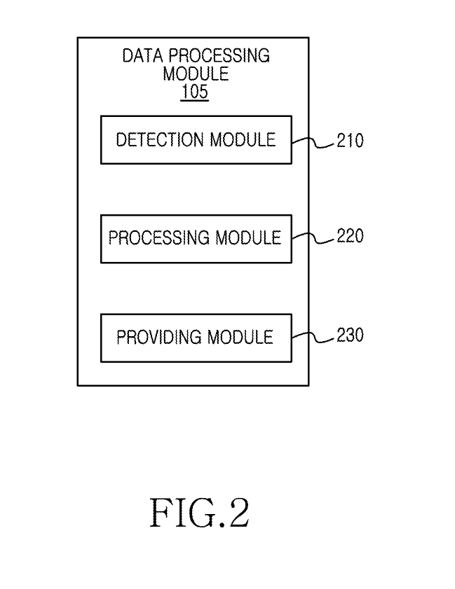

FIG. 2 is a block diagram illustrating an operation processing module in an electronic device according to an embodiment of the present disclosure.

Referring to FIG. 2, a data processing module 105 of an electronic device 101 may include at least one of a detection module 210, a processing module 220, and a providing module 230.

Hereinafter, various embodiments of each module are described.

A user profile processed in a database of the electronic device 101 may include an ID of the electronic device 102 or the electronic device 104 connected via network communication, and information (consumption information) regarding one or more event consumptions, and may be information that has structuralized log data where the electronic device 102 or 104 has accessed and made an activity according to a designated condition. Also, the user profile is not limited to a record where one or more other electronic devices connected with the electronic device 101 have accessed, but may be information that has structuralized log data where the electronic device 101 has directly accessed.

The detection module 210 may process to detect data corresponding to a new user accesses user data of the electronic device 101. The detection module 210 may process to detect data for a user profile not registered in a database of the electronic device 101 or a user profile registered in the database in detecting a new user accesses. Processing module 220 may control to detect comparison group data for obtaining sameness similarity of a data group (e.g., shard) forming a database from a user profile. Processing module 220 may compare sameness or similarity relation between information corresponding to data detected from a user profile or a data group included in a database, and control to obtain information regarding a data group whose sameness and similarity with a user profile represent a designated numerical value or more.

The providing module 230 may control to provide one or more data groups forming a database and a data group (e.g., shard) that has sorted, distributed, and combined one or more user profiles included in a data group according to a method set at the electronic device 101. The providing module 230 may generate a data group having a same or similar range based on a relation degree of one or more user profiles, and control to provide one or more connected data groups having a relation degree of a same or similar range. The providing module 230 may provide to share a connected data group and a user profile included in the connected data group.

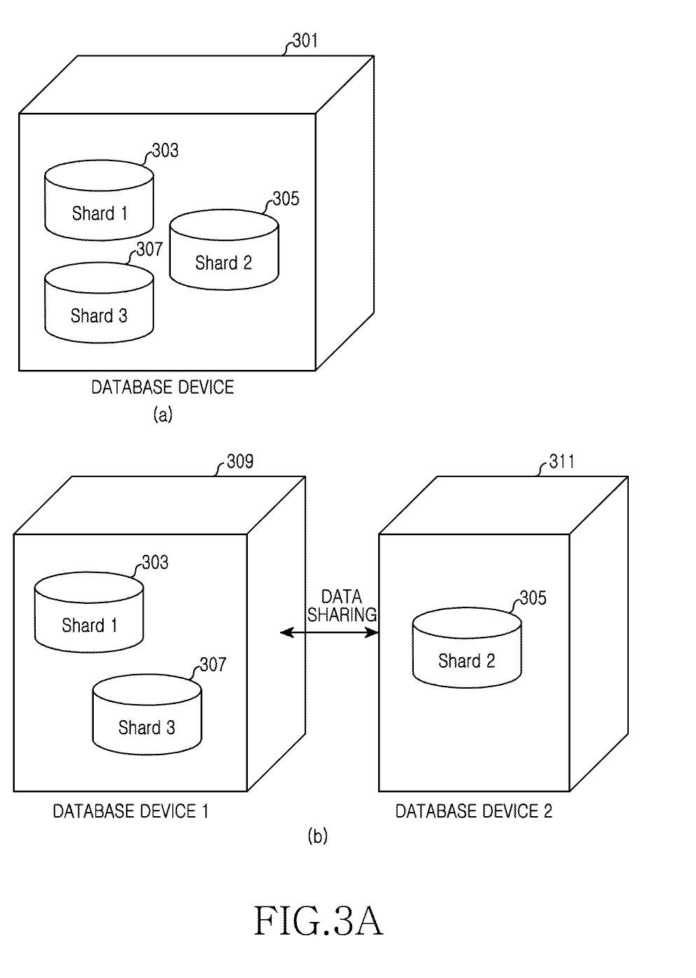

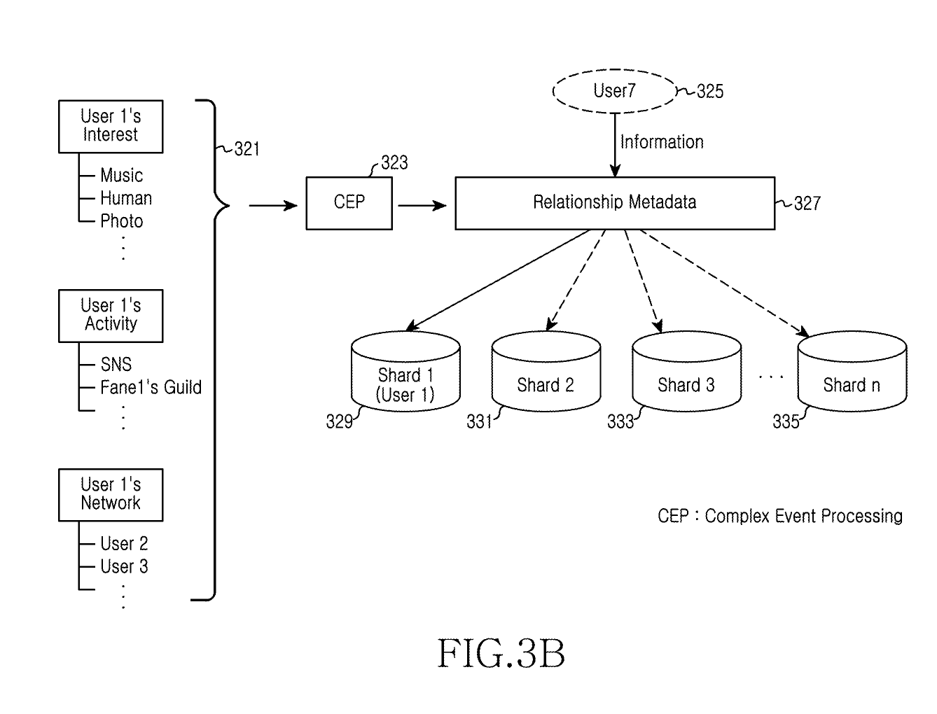

FIGS. 3A and 3B are views illustrating an operation of relating one or more data in an electronic device according to various embodiments of the present disclosure.

Hereinafter, various embodiments of the present disclosure are described with reference to FIG. 3A.

Referring to FIG. 3A, an electronic device 101 is illustrated, where the electronic device 101 may determine an order of priority based on various information related between users, and store data corresponding to a relation degree that depends on various information to form a database in processing information regarding one or more users.

The electronic device 101 may determine relation information between users (user relation information) representing a relation degree between respective users (e.g., coincidence degree, it may be expressed in terms of %) with respect to various conditions included in information for one or more users (e.g., a user profile), and determine a consumption time (e.g., a use time) for conditions having one or more relations. The electronic device 101 may configure a relation between users with reference to user relation information and a use time of related conditions. The electronic device 101 may make a decision using one or more users as a reference among configured relations between users, and determine a user of a designated range as one data group (e.g., shard 1 303, shard 2 305, or shard 3 307 of FIG. 3A) using a user as a reference. The electronic device 101 may determine at least one data group in a database, and in a case where the electronic device 101 includes two or more data groups, the two or more data groups may share data logically.

When the electronic device 101 configures a database, the database may be stored in a storage (e.g., a memory 130) connected with the electronic device 101. The storage may be configured in the outside of the electronic device 101, independently of the electronic device 101, and one or more storages may be connected with the electronic device 101 and/or each storage to transmit/receive data. The electronic device 101 may include information regarding all of data groups included in a database in one physical device (e.g., a database device 301), and include the information on a data group basis in two or more physical devices (e.g., a database device 1 309 or a database device 2 311). In a case of including data regarding a data group in two or more physical devices, each physical device may be connected via wired or wireless network communication, and each physical device may include one or more data groups whose relation degree is high (e.g., higher than a designated value). The electronic device 101 may share a shard included in each database device (e.g., the database device 1 309 or the database device 2 311) and information regarding a user included in the shard.

According to various embodiments, description is made on the assumption that the database device 1 301 in (a) of FIG. 3A and the database device 2 311 in (b) of FIG. 3A are the same database device with reference to FIG. 3A.

The electronic device 101 may include a data group of the shard 1 303, the shard 2 305, and the shard 3 307 in the database device 301 in (a) of FIG. 3A. In a case where the electronic device 101 intends to additionally add one or more data groups (e.g., a shard 4) having relation similarity with the shard 2 305 to the database device 301, the electronic device 101 may not additionally include the shard 4 for a residual memory (e.g., a storage space) of the database device 301 is insufficient. The electronic device 101 may determine one or more other shards (e.g., a shard 1 and a shard 3) whose relation similarity with the shard 2 is low (e.g., lower that a designated value) in the database device 301. Here, the shard 1 and the shard 3 determined by the electronic device 101 may be data groups whose group relation similarity between them is higher than a designated numerical value. The electronic device 101 may transmit the determined shard 1 and shard 3 to the new database device 1 309 or a database device including one or more shards having relation similarity with the shard 1 and the shard 3. The electronic device 101 may delete (e.g., the database device 2 311) data regarding the shard 1 and the shard 3 transmitted by the database device 301, and include a shard 4 in a secured residual memory of the database device 2 311.

Hereinafter, various embodiments of the present disclosure are described with reference to FIG. 3B.

Referring to FIG. 3B, in a case of including a user profile in a database, an electronic device 101 may include the user profile in a relevant database group with reference to one or more of various conditions forming a data group of the database.

According to an embodiment, the electronic device 101 may establish a database including one or more data groups (e.g., a shard 1 329, a shard 2 331, a shard 3 333 and a shard n 335). The electronic device 101 may refer to one or more information included in a user profile in order to determine a user profile included in a shard. The electronic device 101 may collect information regarding an event such as a user's (e.g., user 1) interest (e.g., favorite music, a user's tendency, information regarding a shooting position or a person photographed together in a case of including image data), a user's (e.g., user 1) activity (e.g., a social network service, games, activity information regarding a social network inside a game), and one or more other users who may be connected with a user on the user's (e.g., user 1) network (e.g., contact information of the electronic device 101, information for other users via an electronic mail address book) to form a comparison group 321, and determine a relation with other users with reference to one or more of comparison groups. 321 of FIG. 3B may be comparison group data represented for a user 1 in comparison group data for one or more users included in a database of the electronic device 101. The electronic device 101 may include one or more user profiles included in a database by configuring each comparison group data, and configure a comparison group data in the form of a data table or a list. Data of the above event is stream data, and may be data input in large quantities or constantly, data where a value is given to a time sequence, and data repeated continuously or processed continuously without termination.

The electronic device 101 may analyze the above-described event data via a Complex Event Processing (CEP) 323 module, and determine a shard (e.g., a shard 1 329 of a user 1) whose relation degree with a user 7 profile with reference to a profile of an input user 7 325. The electronic device 101 may obtain a comparison group data for information collected for the user 7 325 from meta data of the profile of the user 7 325 via the CEP module 323, and compare the comparison group data of the user 7 325 with comparison group data included in the database of the electronic device 101 to determine a shard 1 329 whose relation degree with the profile of the user 7 is high. Here, the CEP 323 module may include all or a portion of functions of a generally used complex event processing module, and analyze and process the above-described event data (or stream data) in real-time. The electronic device 101 may record a profile of the user 7 in relation-based meta data that manages a database, and transmit data regarding the user 7 profile to a region of the shard 1 329.

In a case of not being able to determine a relation degree of a designated numerical value or more that may include one or more shards included in a database in processing a profile of the user 7 325, the electronic device 101 may generate a new shard (e.g., a shard n 325), and configure a data group forming a relation using the profile of the user 7 325 as a reference. The electronic device 101 may record information (e.g., information, etc. for a shard including the user 7 323 profile) determined for the user 7 325 profile in relationship metadata 327 of a database. The metadata 327 of the database may include information regarding one or more comparison group data 321 included in the database.

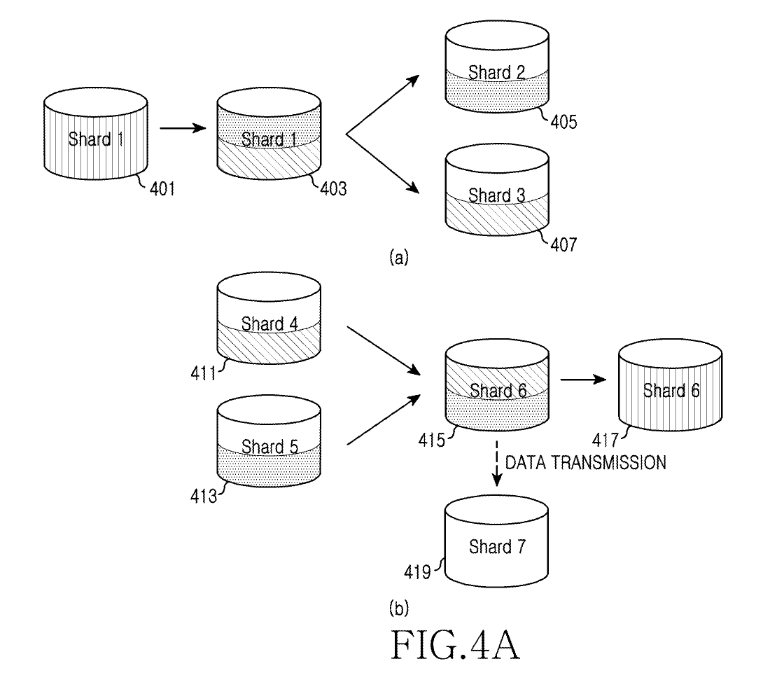

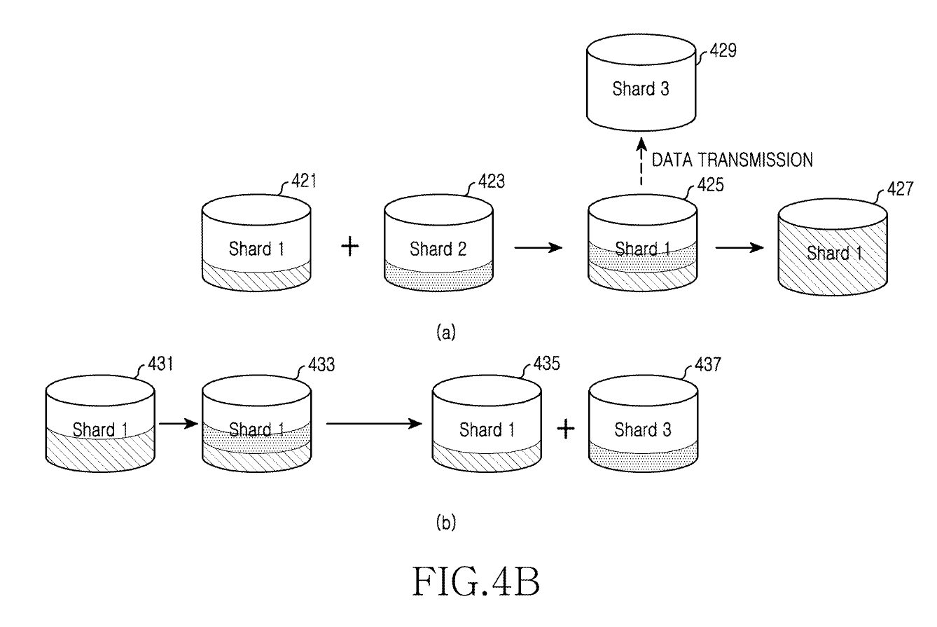

FIGS. 4A and 4B are views illustrating an operation of relating one or more data in an electronic device according to various embodiments of the present disclosure.

Hereinafter, various embodiments of the present disclosure are described with reference to FIG. 4A.

Referring to FIG. 4A, an electronic device 101 may divide one shard into two or more shards, and merge two or more shards into one shard. Referring to (a) of FIG. 4A, the electronic device 101 may divide data regarding one or more user profiles included in a shard 1 401 into two or more groups based on a relation degree, and determine each group as a new shard. The electronic device 101 may refer to various conditions (e.g., event data) described in FIG. 3B in dividing a user profile included in the shard 1 401 into two or more groups. The electronic device 101 may detect a user profile serving as a reference has changed in a shard formed using one user profile (e.g., a profile of a user 1) as a reference (order of priority in importance). Each shard forming a database may change a user profile serving as a reference depending on an activation degree of the user profile. Here, the activated degree may be data that digitizes a period at which one or more data included in a user profile or connected to the user profile by a user changes, and a time for which an event included in a user profile is consumed, etc., and may be determined with reference to activation information of one or more other users connected with the user.

The electronic device 101 may divide (403) data (e.g., logically related two or more user profile data) of one shard 1 401 into two or more data. The electronic device 101 may determine a user profile serving as a reference in the data of the divided shard 1 403 to form each shard. The electronic device 101 may determine a user 2 profile and a user 3 profile whose activation degree is high among user profiles of the shard 1 401, and separate data of the shard 1 401 using the user 2 profile and the user 3 profile as a reference. The electronic device 101 may determine data formed based on the user 2 profile as a new shard 2 405, and determine data formed based on the user 3 profile as a new shard 3 407. The electronic device 101 may process information regarding a user profile via the shard 2 or the shard 3 newly formed in the database. The electronic device 101 may include the separated shard 2 and shard 3 in the same database device, and transmit one or more shards to another database device. Even though regions of data of the shard 2 and the shard 3 are separated logically or physically, data may be transmitted/received between respective shards under control of the electronic device 101, and information regarding a user profile or event data included in each shard may be shared. According to the above embodiment, though an operation where the electronic device 101 divides a shard 1 into two shards (e.g., a shard 1 and a shard 2) has been described, it is obvious that the operation is not limited to dividing the shard 1 into two shards but the shard 1 may be divided into two or more shards. Also, an operation that combines two shards into one shard may also combine two or more shards into one shard.

Referring to (b) of FIG. 4A, the electronic device 101 may combine shards such that data (e.g., logically related two or more user profile data) included in two or more shards (e.g., a shard 4 411, a shard 5 413) is included in one shard (e.g., a shard 6 415). The electronic device 101 may determine a user profile (e.g., user 6 or shard 6 417) whose activation degree is high in a shard 6 415. The electronic device 101 may reconfigure data included in the shard 6 415 based on the user 6 whose activation degree is high, and determine some user profile whose relation degree with the user 6 is lower than the designated numerical value. The electronic device 101 may determine a shard (e.g., shard 7 419) formed of a user profile (e.g., profile of a user 7) whose relation degree with some user profile is high (equal to or greater than a designated numerical value) via a CEP (e.g., the CEP module 323 of FIG. 3B), and transmit some profile (data) whose relation degree is low to the shard 7 whose relation degree is high based on the user 6 profile of the newly formed shard 6. The electronic device 101 may obtain information regarding one or more shards whose relation degree with data of a reconfigured shard 6, and transmit/receive or share data under control of the electronic device 101.

Hereinafter, various embodiments of the present disclosure are described with reference to FIG. 4B.

Referring to (a) of FIG. 4B, an electronic device 101 may allow data (e.g., logically related two or more user profile data) of one or more shards (e.g., shard 2 423) to be included in one shard (e.g., shard 1 425). The electronic device 101 may reconfigure data included in a shard (e.g., shard 2 of a user 2 profile) of a user profile whose relation degree is high based on a user profile (e.g., a profile of a user 1) of a shard 1 421 using a profile of a user 1 of a shard 1 421 as a reference. In a case where data of the shard 2 423 is included in the shard 1 421, the electronic device 101 may determine a relation degree of data of one or more user profiles included in the shard 2 and the user 1 profile serving as a reference of the shard 1 421. The electronic device 101 may reconfigure data for one or more user profiles included in a shard 2 423 as data of the shard 1 427 depending on a relation degree with data of a user 1 profile. The electronic device 101 may determine data for some user profiles of the shard 2 423 whose relation degree is lower than a designated numerical value in reconfiguring data of the shard 2 423 depending on the user 1 profile serving as a reference of the shard 1 421. The electronic device 101 may determine a shard (e.g., shard 3 429) formed based on a user profile (e.g., user 3 profile) whose relation degree with some user profiles is high via a CEP module (e.g., the CEP module 323 of FIG. 3B), and transmit some user profiles (data) whose relation degree is low in the shard 1 425 to a shard 3 429 whose relation degree is high. The electronic device 101 may obtain information regarding one or more shards whose relation degree with data of a reconfigured shard 1 429, and transmit/receive or share data under control of the electronic device 101.

Referring to (b) of FIG. 4B, an electronic device 101 may divide data (e.g., logically related two or more user profile data) included in one shard 1 431 into two or more data of shard 1 433. In dividing data included in the shard 1 431, the electronic device 101 may compare data with data of a user profile (e.g., user 1 profile) serving as a reference of the shard 1 431 to determine one or more user profiles (e.g., user 3 profile) representing an activation degree higher than a designated numerical value. The electronic device 101 may compare a user 1 profile and a user 3 profile in user profiles included in the shard 1 to determine one or more user profiles whose relation degree with the user 3 profile is high. The electronic device may generate a new shard (e.g., shard 3 437) formed of the user 3 profile and the determined one or more user profiles and separate the same from the shard 1 435. The electronic device 101 may allow the separated shard 1 435 and shard 3 437 to be included in the same database device, and transmit one or more shards to another database device. Even though regions of data of the shard 1 435 and the shard 3 437 are separated logically or physically, data may be transmitted/received between respective shards under control of the electronic device 101, and information regarding a user profile or event data included in each shard may be shared. According to the above embodiment, though an operation where the electronic device 101 forms some data included in the shard 1 435 as one shard (e.g., shard 3 437) has been described, it is obvious that the operation is not limited to forming the data as one shard but the data may be formed as two or more shards.

Referring to FIGS. 3A to 4B, the electronic device 101 is not limited to an operation of allowing two or more shards and data included in the shards to be included in one shard, or an operation of forming one shard and data included in the shard as two or more shards and separating them. The electronic device 101 may allow one or more user profiles and data for the user profiles to be included in each shard, or transmit the same to another shard or configure a new shard. In performing an operation of adding a user profile and data for the user profile to one shard or transmitting the same to another shard, the electronic device 101 may periodically detect a relation degree of a shard included in a database and a user profile included in each shard, and perform operations such as combining, separating the shard, or moving a user profile with reference to the detected relation degree and a condition set to the electronic device 101.

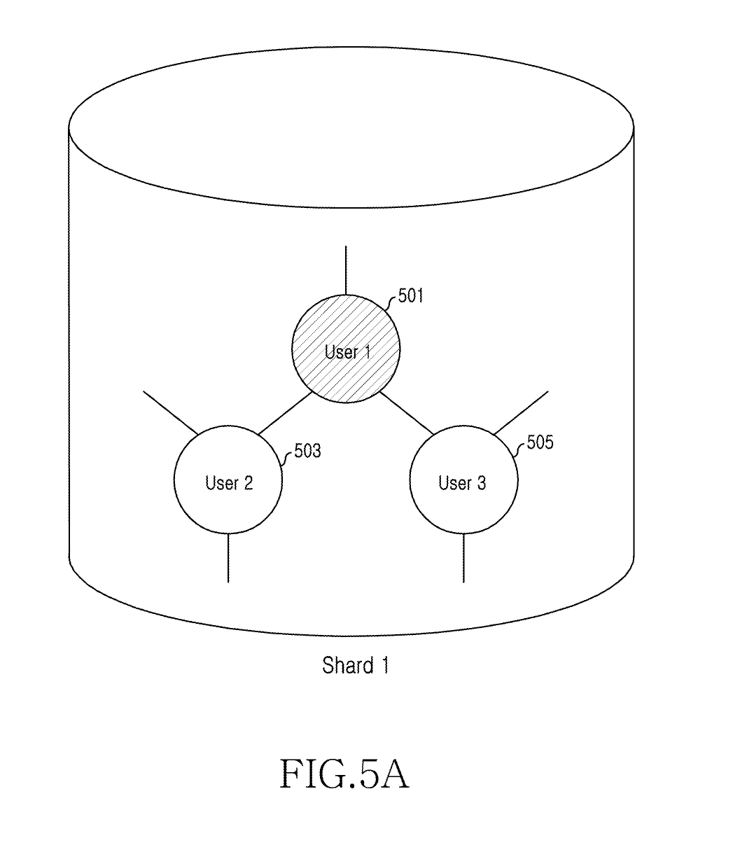

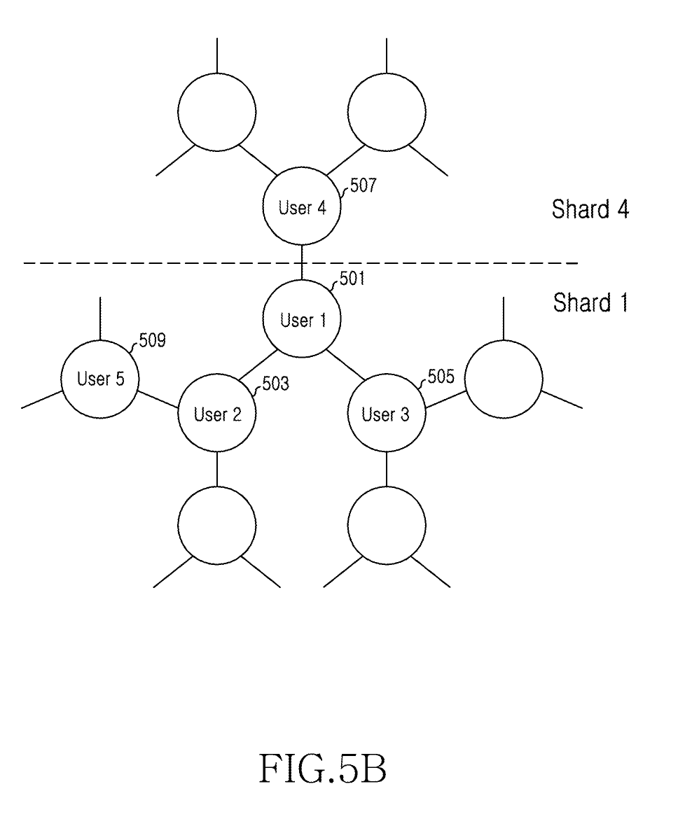

FIGS. 5A and 5B are views illustrating an operation of relating one or more data in an electronic device according to various embodiments of the present disclosure.

Hereinafter, various embodiments of the present disclosure are described with reference to FIG. 5A.

Referring to FIG. 5A, a diagram is illustrated to represent a relation of a user profile included in one shard or a connection state of a user profile included in one shard. An electronic device 101 may determine one or more user profiles higher than a designated numerical value with reference to a relation degree between data (e.g., a user profile) included in a database and an activation degree of data. The electronic device 101 may determine an order of priority of data (e.g., one or more user profiles) included in a database using the determined one or more user profiles as a reference. The electronic device 101 may determine data included in a database in a sequence where a relation degree with user profiles (e.g., user 1 profile 501, user 2 profile 503, or user 3 profile 505) serving as a reference is the same or a similarity degree with the user profiles (information digitized according to a designated condition) is high in determining an order of priority of the data included in the database. The electronic device 101 may configure the determined one or more user profiles that depend on the order of priority as a radial network around user profiles (e.g., user 1 profile 501, user 2 profile 503, or user 3 profile 505) serving as a reference. The electronic device 101 may determine a predetermined range of the network configured around the user profiles serving as a reference to determine the same as one data group (e.g., shard 1). The electronic device 101 may determine one or more other shards (e.g., shard 2 or shard 3) whose relation degree with one shard (e.g., shard 1) is high, and share a user profile and/or various data included in the user profile between respective shards.

A user profile included in the database may be configured in the form of a list or a data table where various information collected via the electronic device 101 or network communication connected with the electronic device 101 is discriminated according to a designated category with respect to a relevant user.

Hereinafter, various embodiments of the present disclosure are described with reference to FIG. 5B.

Referring to FIG. 5B, an electronic device 101 may determine a shard 4 configured based on a user 4 profile 507 representing comparison group data which is the same as or similar to the shard 1 configured based on a user 1 profile 501 in a database. The electronic device 101 may logically connect the shard 1 and the shard 4 and share data. In connecting the shard 1 and the shard 4, the electronic device 101 may connect the shard 1 and the shard 4 in a logical structure having the radial network such as the diagram illustrated in FIG. 5B.

The electronic device 101 not only combines one shard (e.g., shard 1) or one or more shards whose relation degree is the same as or similar to a user 1 profile serving as a reference of the shard 1 or a user profile, but also compares comparison group data of a user profile (e.g., a user 5 profile 509) included in another shard or comparison group data of a user profile (e.g., a user 3 profile 505) not included in any shard of a database, and comparison group data of a user profile (e.g., a user 2 profile 503) included in the shard 1. In a case where the comparison result represents a relation degree higher than a designated numerical value, the electronic device 101 may connect the user 5 profile 509 with a relevant user 2 profile 503 in a logical structure.

According to an embodiment, in a case where a user 1 profile 501, a user 2 profile 503, and a user 5 profile 509 included in one shard (e.g., shard 1) are connected in a vertical structure, the vertical structure may be a structure corresponding to a relation degree determined via comparison of respective comparison group data, and does not represent a hierarchical structure that should be passed through when the electronic device 101 processes data. It is obvious that the electronic device 101 may directly process each data without passing through the user 2 profile 503 in processing some data of the user 1 profile 501 and some data of the user 5 profile 509 simultaneously.

In various embodiments of the present disclosure, a shard forming a database of the electronic device 101 and a user profile may be terminologies expressing data itself (data having a substantial capacity) stored in the memory 130 of the electronic device 101, and may be data (e.g., index data) describing a data logical structure or serving as an index of stored data. In a case where a shard and a user profile are index data, the electronic device 101 may filter a user profile depending on one or more items included in comparison group data, and obtain an order of priority of a user profile that depends on a selected item. The electronic device 101 may sort data dispersed and stored in a plurality of database devices by filtering index data to configure a user profile or a shard.

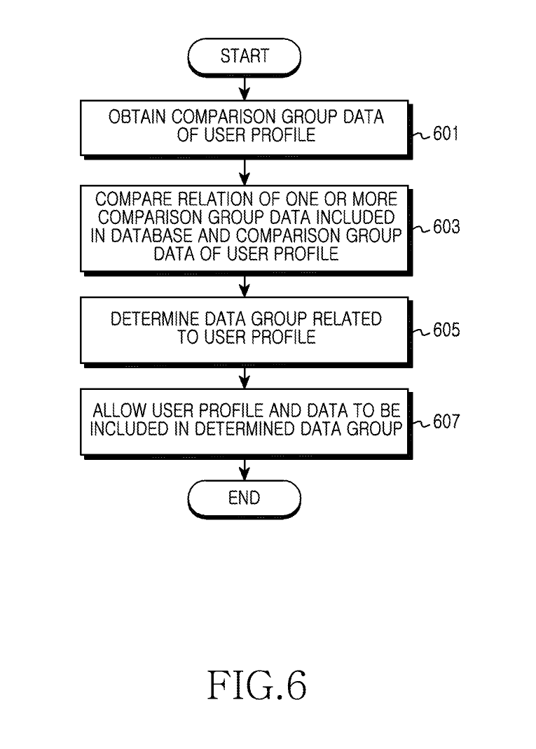

FIG. 6 is a flowchart illustrating an operation of relating one or more data in an electronic device according to an embodiment of the present disclosure.

Referring to FIG. 6, an operation is illustrated where an electronic device 101 may obtain information of a different electronic device that has accessed the electronic device 101 one or more times or a user who has directly accessed the electronic device 101, and generate a user profile using the obtained information. The electronic device 101 may allow the obtained one or more user profiles to be included in one or more data groups depending on setting determined in the database of the electronic device 101.

In operation 601, the electronic device 101 may obtain one or more comparison group data corresponding to a condition determining a data group (e.g., shard) of a user profile from a user 1 profile obtained or detected by the electronic device 101. The electronic device 101 may obtain information such as a pattern in which a user 1 consumes, a consumed time range, and a consumed ratio with respect to one or more events which the electronic device 101 may collect via data including information of the user 1 profile or the user 1 to configure comparison group data. Here, the above-described comparison group data may be included in metadata of data including the user 1 profile or information of the user.

In operation 603, the electronic device 101 may compare comparison group data included in a database or a chart where one or more comparison group data included in the database have been organized with the comparison group data obtained in operation 601. The electronic device 101 may compare a relation degree with one or more items included in the comparison group data.

In operation 605, the electronic device 101 may compare a relation degree of comparison group data to determine a data group (e.g., shard) having a tendency which is the same as or similar to the user 1 profile obtained in operation 601. According to an embodiment, the electronic device 101 may determine a user profile or a shard having a tendency which is the same as or similar to an event consumption tendency (relation degree) of the user profile obtained in operation 603 with reference to information for one or more shards included in a database and the user 2 profile serving as a reference forming a shard or one or more comparison group data of the user 3 profile included in a shard.

In operation 607, the electronic device 101 may include a shard which is the same as or similar to a tendency of the user 1 profile obtained in operation 603, or in a case of determining a user profile, the electronic device 101 may allow data of the user 1 profile to be included in a determined shard, or connect the data with a user profile whose relation degree included in a shard is the same or similar (meeting a designated numerical value). According to an embodiment, the electronic device 101 may allow an obtained user profile to be included in the shard 1, and determine a sorted position of the obtained user 1 profile with reference to a relation degree with the user 1 profile serving as a reference of the shard 1 or a relation degree of one or more user profiles included in the shard 1.

When the electronic device 101 performs operation 607, the embodiment of FIG. 6 may be ended.

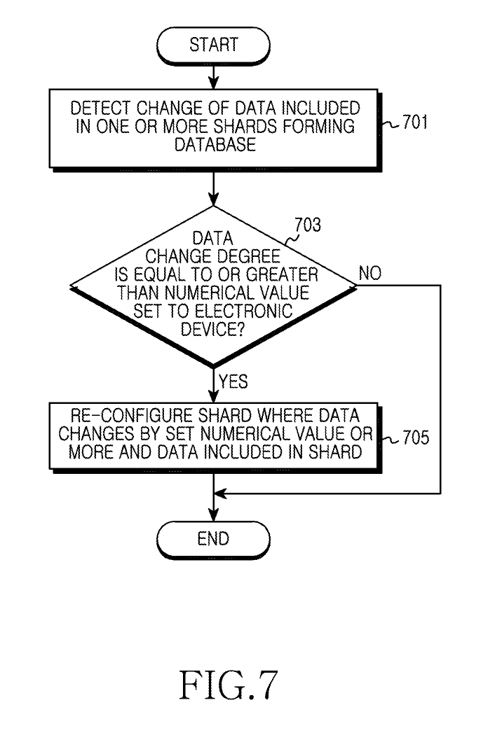

FIG. 7 is a flowchart illustrating an operation of relating one or more data in an electronic device according to an embodiment of the present disclosure.

In a case of detecting a change where a shard forming a database or information of a user profile forming the shard corresponds to a value equal to or greater than a numerical value (or a ratio) set by an electronic device 101, the electronic device 101 may reconfigure information included in a database of the electronic device 101.

Referring to FIG. 7 an operation is illustrated, such that in operation 701, the electronic device 101 may detect that a shard forming a database or some data (e.g., a user profile) of the shard changes. The electronic device 101 may detect a state of a shard of the database or a user profile included in the shard in real-time or at a designated period. In a case of detecting a state of a shard of a database and a user profile included in the shard in real-time, the electronic device 101 may detect a change of a user's event (or contents) consumption information or an event (or contents) consumption pattern as a time elapses. The electronic device 101 may apply detected information to a relevant user profile of a database.

In operation 703, the electronic device 101 may detect that a user's event consumption information or an event consumption pattern changes via a user profile or a shard, and in a case where the detected information is higher than a designated numerical value, the electronic device 101 may determine to reconfigure all or a portion of information of the database such as a region (e.g., shard) including a relevant user profile and a relevant shard.

In a case of determining to reconfigure information of the database, the electronic device 101 may perform operation 705, and in a case of determining to maintain information of the database, the embodiment of FIG. 7 may be ended.

In operation 705, the electronic device 101 may reconfigure all or a portion of data of the database whose reconfiguration has been determined with reference to setting information set to the electronic device 101. According to an embodiment, in a case of detecting that a user 1′s activity position changes from America to Korea with reference to a user 1 profile, the electronic device 101 may determine a relation degree for one or more shards corresponding to a database Korea region or a user profile included in the shard so that the user 1 profile may be moved from a shard positioned in America region to a shard positioned in Korea region. As described above, the electronic device 101 may compare not only a user's activity position but also information for various items such as a user's event consumption time, an event consumption pattern, an event consumption field to determine a data group (e.g., shard) which is to include a user profile with reference to a user profile. In reconfiguring a shard (or all or a portion of a database) including a user profile, the electronic device 101 may transmit/receive data corresponding to the user profile from an existing database device to a different database device.

When the electronic device 101 performs operation 705, the embodiment of FIG. 7 may be ended.

According to various embodiments, a method for processing data of an electronic device is provided. The method may include determining two or more data groups having group relation similarity from a plurality of data groups each including information of one or more users, transmitting the determined two or more data groups to a second electronic device, and deleting them from the electronic device.

According to various embodiments, each of the plurality of data groups may perform obtaining information of a plurality of users, obtaining one or more consumption information included in each of the information of the plurality of users, determining relation similarity of the information of the users based on the one or more consumption information, and when the information of the users have the relation similarity, storing the information of the users in a same data group to generate the same.

According to various embodiments, the method may further include, under a circumstance where a plurality of data groups including a first group which is the same data group exist, transmitting a second group having the group relation similarity with the first group together with the first group.

According to various embodiments, the consumption information may include one or more of a user's favorite music information included in user information, a user's tendency information, information regarding a shooting position or a person photographed together in a case of including image data, a user's social network service information, game information, activity information for a social network inside a game, contact information for one or more other users that may be connected with a user, and electronic mail address information.

According to various embodiments, each of the plurality of data groups may include information of the some users having the relation similarity based on information of one user having an activation degree is high (e.g., higher than a designated numerical value).

According to various embodiments, the method may allow one or more data groups having the relation similarity with the same data group to be included in the same database device.

According to various embodiments, two or more data groups having the relation similarity may share data.

According to various embodiments, the method may further include detecting information of some users of information of the users changes by a designated ratio or more, and re-determining a data group having relation sameness or similarity with the detected information of the some users.

According to various embodiments, the method may separate one of the data groups into two or more data groups. According to an embodiment, the separation of the one of the data groups may configure a separate data group based on information of some users representing an activation degree that is equal to or greater than a designated numerical value, included in one of the data groups.

According to various embodiments, the method may configure one data group using a portion of two or more data groups having the relation similarity of a designated numerical value or more. According to various embodiments, the one data group may connect information of remaining users of the one data group based on one user profile having an activation degree that is high (e.g., higher than a designated numerical value).

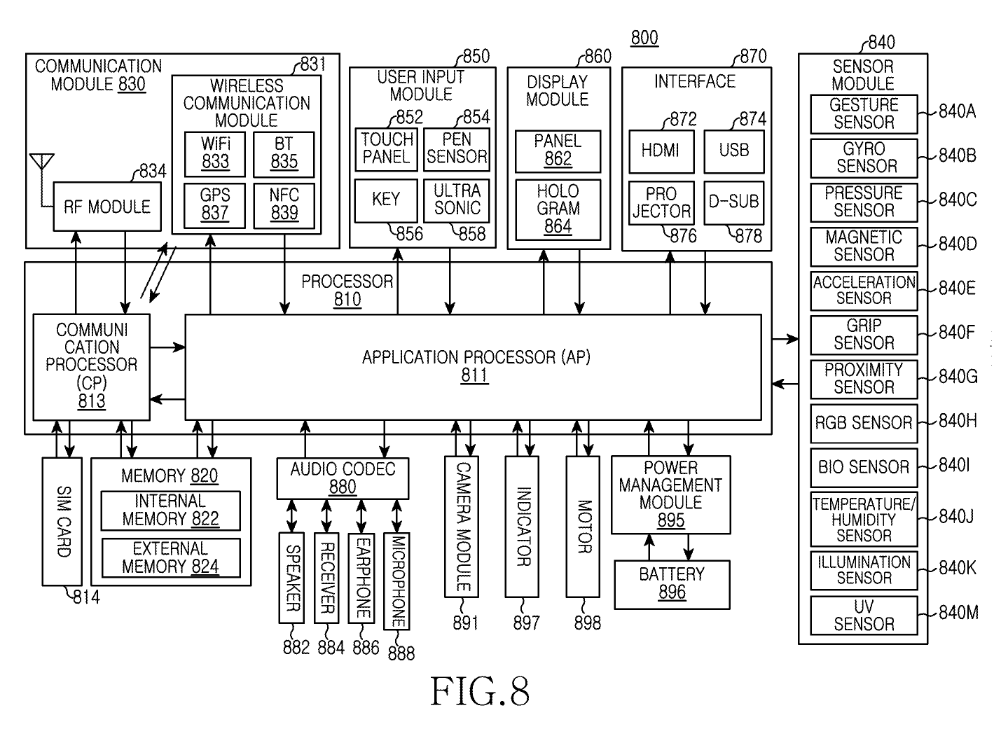

FIG. 8 is a block diagram illustrating hardware according to an embodiment of the present disclosure.

The hardware may configure, for example, all or a portion of the electronic device 101 illustrated in FIG. 1.

Referring to FIG. 8, hardware 800 is illustrated, where the hardware 800 may include one or more processors 810, a SIM card 814, a memory 820, a communication module 830, a sensor module 840, a user input module 850, a display module 860, an interface 870, an audio codec 880, a camera module 891, a power management module 895, a battery 896, an indicator 897, and/or a motor 898.

The processor 810 (e.g., the processor 120 of FIG. 1) may include one or more application processors (AP) 811 or one or more communication processors (CP) 813. The processor 810 may be, for example, the processor 120 illustrated in FIG. 1. Though the AP 811 and the CP 813 are included inside the processor 810 in FIG. 8, the AP 811 and the CP 813 may be included inside different IC packages, respectively. According to an embodiment, the AP 811 and the CP 813 may be included inside one IC package.

The AP 811 may drive an Operating System (OS) or an application to control a plurality of hardware or software elements connected to the AP 811, and perform various data processing including multimedia data and operations. The AP 811 may be, for example, implemented as a System-on-Chip (SoC). According to an embodiment, the processor 810 may further include a Graphics Processing Unit (GPU) (not shown).

The CP 813 may perform a function of managing a data link and converting a communication protocol in communication between other electronic devices connected with an electronic device (e.g., the electronic device 81) including the hardware 800 via a network. The CP 813 may be implemented as an SoC, for example. According to an embodiment, the CP 813 may perform at least a portion of a multimedia control function. The CP 813 may, for example, perform discrimination and authentication of a terminal inside a communication network using a subscriber identifying module (e.g., a SIM card 814). Also, the CP 813 may provide services such as voice communication, video communication, a text message, or packet data, etc. to a user.

Also, the CP 813 may control data transmission/reception of the communication module 830. Though elements such as the CP 813, the power management module 895 or the memory 820 are illustrated as separate elements independent of the AP 811 in FIG. 8, according to an embodiment, the AP 811 may be implemented to include at least a portion (e.g., the CP 813) of the above-described elements.

According to an embodiment, the AP 811 or the CP 813 may load an instruction or data received from at least one of a non-volatile memory or other elements connected thereto to a volatile memory and process the same. Also, the AP 811 or the CP 813 may receive data received from at least one of other elements or may store data generated by at least one of other elements in a non-volatile memory.

The SIM card 814 may be a card that implements a subscriber identifying module, and may be inserted into a slot formed in a specific position of the electronic device. The SIM card 814 may include unique identify information (e.g., an Integrated Circuit Card identifier (ICCID)) or subscriber information (e.g., an International Mobile Subscriber identity (IMSI)).

The memory 820 may include a built-in (e.g., internal) memory 822 or an external memory 824. The memory 820 may be, for example, the memory 130 illustrated in FIG. 1. The built-in memory 822 may include, for example, at least one of a volatile memory (e.g., Dynamic Random-Access Memory (DRAM), Static Random-Access Memory (SRAM), Synchronous Dynamic Random-Access Memory (SDRAM), etc.) and a non-volatile memory (e.g., One-Time Programmable Read Only Memory (OTPROM), Programmable Read Only Memory (PROM), Erasable Programmable Read Only Memory (EPROM), Electrically Erasable Programmable Read Only Memory (EEPROM), mask Read Only Memory (ROM), flash ROM, Negated AND (NAND) flash memory, NOR flash memory, etc.). According to an embodiment, the built-in memory 822 may have a form of a Solid State Drive (SSD). The external memory 824 may further include a flash drive, for example, Compact Flash (CF), Secure Digital (SD), Micro-SD, Mini-SD, xD, or Memory Stick, etc.

The communication module 830 may include a wireless communication module 831 and/or an RF module 834. The communication module 830 may be, for example, the communication interface 160 illustrated in FIG. 1. The wireless communication module 831 may include, for example, WiFi 833, BT 835, GPS 837, or NFC 839. For example, the wireless communication module 831 may provide a wireless communication function using a radio frequency. Additionally or alternatively, the wireless communication module 831 may include a network interface (e.g., LAN card) or a modem, etc. for connecting the hardware 800 with a network (e.g., the Internet, LAN, WAN, telecommunication network, cellular network, satellite network, or POTS, etc.).

The RF module 834 may take charge of transmission/reception of data, for example, transmission/reception of an RF signal or a called electronic signal. Though not shown, the RF module 834 may include, for example, a transceiver, a PAM, a frequency filter, or an LNA, etc. Also, the RF module 834 may further include a part for transmitting/receiving a radio wave in a free space, for example, a conductor or a conducting line, etc.

The sensor module 840 may include, for example, at least one of a gesture sensor 840A, a gyro sensor 840B, an atmospheric pressure sensor 840C, a magnetic sensor 840D, an acceleration sensor 840E, a grip sensor 840F, a proximity sensor 840G, a Red Blue Green (RGB) sensor 840H, a living body (e.g., BIO) sensor 8401, a temperature/humidity sensor 840J, an illumination sensor 840K, and/or a UV sensor 840M. The sensor module 840 may measure a physical quantity or detect an operation state of the electronic device to convert the measured or detected information to an electric signal. Additionally/alternatively, the sensor module 840 may include, for example, a smell sensor (not shown), an Electromyography (EMG) sensor (not shown), an Electroencephalography (EEG) sensor (not shown), an Electrocardiogram (ECG) sensor (not shown), or a fingerprint sensor, etc. The sensor module 840 may further include a control circuit for controlling at least one sensor belonging thereto.

The user input module 850 may include a touch panel 852, a (digital) pen sensor 854, a key 856, or an ultrasonic input unit 858. The user input module 850 may be, for example, the I/O interface 140 illustrated in FIG. 1. The touch panel 852 may recognize a touch input using, for example, at least one of capacitive, resistive, an infrared or ultrasonic method. Also, the touch panel 852 may further include a controller (not shown). A capacitive touch panel may perform not only a direct touch but also proximity recognition. The touch panel 852 may further include a tactile layer. In this case, the touch panel 852 may provide a tactile reaction to a user.

The (digital) pen sensor 854 may be implemented using, for example, a method which is the same as or similar to receiving a user's touch input, or a separate sheet for recognition. For the key 856, a keypad or a touch key may be used, for example. The ultrasonic input unit 858 is a unit for determining data by detecting a sound wave from a terminal to a microphone (e.g., the microphone 888) via a pen that generates an ultrasonic signal. The ultrasonic input unit 858 can perform wireless recognition. According to an embodiment, the hardware 800 may receive a user input from an external device (e.g., a network, a computer or a server) connected thereto using the communication module 830.

The display module 860 may include a panel 862 or a hologram 864. The display module 860 may be, for example, the display module 150 illustrated in FIG. 1. The panel 862 may be, for example, a Liquid Crystal Display (LCD) or an Active Matrix Organic Light Emitting Diode (AM-OLED). The panel 862 may be implemented such that it is flexible, transparent, or wearable, for example. The panel 862 may be configured as one module together with the touch panel 852. The hologram 864 may show a three-dimensional image in a vacant space using interferences of light. According to an embodiment, the display module 860 may further include a control circuit for controlling the panel 862 or the hologram 864.

The interface 810 may include, for example, a High-Definition Media Interface (HDMI) 812, a Universal Serial Bus (USB) 814, a projector 816, or a D-sub 818. Additionally, or alternatively, the interface 810 may include, for example, a Secure Digital/Multimedia Card (SD/MMC) interface (not shown) or an Infrared Data Association (IrDA) interface (not shown).

The audio codec 880 may convert voice and an electric signal in both directions. The audio codec 880 may convert, for example, voice information input or output via a speaker 882, a receiver 884, an earphone 886, and/or a microphone 888, etc.

The camera module 891 is a device for shooting an image and a moving picture. According to an embodiment, the camera module 891 may include one or more image sensors (e.g., a front lens or a rear lens), an ISP (not shown), or a flash LED (not shown).

The power management module 895 may manage power of the hardware 800. Though not shown, the power management module 895 may include, for example, a Power Management Integrated Circuit (PMIC), a charging Integrated Circuit (IC), or a battery gauge.

The PMIC may be, for example, mounted inside an integrated circuit or an SoC semiconductor. A charging method may be classified into a wired method and a wireless method. The charging IC may charge a battery, and prevent an overvoltage or an overcurrent from being introduced from a charger. According to an embodiment, the charging IC may include a charging IC for at least one of the wired charging method and the wireless charging method. For the wireless charging method, there are a magnetic resonance method, a magnetic induction method, or an electromagnetic wave method, etc., for example. In this case, an additional circuit for wireless charging, for example, a circuit such as a coil loop, a resonance circuit, a rectifier, etc. may be added.

The battery gauge may measure, for example, a remnant of the battery 896, a voltage, a current, or temperature during charging. The battery 896 may generate electricity to supply power, and may be, for example, a rechargeable battery.

The indicator 897 may display a specific state of the hardware 800 or a portion of the hardware 800 (e.g., the AP 811), for example, a booting state, a message state, or a charging state, etc. The motor 898 may convert an electric signal to mechanical vibration. The MCU 899 may control the sensor module 840.

Though not shown, the hardware 800 may include a processing unit (e.g., GPU) for supporting a mobile TV. The processing unit for supporting the mobile TV may process, for example, media data according to a standard such as Digital Multimedia Broadcasting (DMB), Digital Video Broadcasting (DVB), or a media flow, etc. Each of the above-described elements of the hardware according to various embodiments of the present disclosure may be configured using one or more parts, and a name of a relevant element may change depending on a kind of the electronic device. The hardware according to various embodiments of the present disclosure may include at least one of the above-described elements, and a portion of the elements may be omitted or additional other elements may be further included. Also, a portion of the elements of the hardware according to various embodiments of the present disclosure combines to form one entity and equally perform the function of relevant elements before the combination.

According to the various embodiments, the electronic device may include a memory including information for one or more users, a data processing module configured to determine two or more data groups having a group relation similarity, the two or more groups being confirmed from a plurality of data groups each including the information of one or more users, to transmit the determined two or more data groups to another electronic device, and to delete the two or more data groups transmitted to the other electronic device from the electronic device, and one or more processors configured to control the data processing module.

According to various embodiments, the data processing module may obtain information of a plurality of users with respect to each of the plurality of data groups, obtain one or more consumption information included in each of the information of the plurality of users, determine relation similarity of the information of the users based on the one or more consumption information, and when the information of the users has the relation similarity, store the information of the users in a same data group to generate the data group.

According to various embodiments, under a circumstance where a plurality of data groups including a first group, which is the same data group, exists, the data processing module may transmit a second group having the group relation similarity with the first group together with the first group.

According to various embodiments, the data processing module may allow the consumption information to comprise one or more of a user's favorite music information included in user information, a user's tendency information, information regarding a shooting position or a person photographed together in a case of including image data, a user's social network service information, game information, activity information for a social network inside a game, contact information for one or more other users that is connectable with a user, and electronic mail address information.

According to various embodiments, the data processing module may configure each of the plurality of data groups to include information of the some users having the relation similarity based on information of one user having an activation degree that is higher that a designated numerical value.

According to various embodiments, the data processing module may allow one or more data groups having the relation similarity with the same data group to be included in the same database device.

According to various embodiments, the data processing module may control two or more data groups having the relation similarity to share data.

According to various embodiments, the data processing module may detect information of some users of information of the users changes by a designated ratio or more, and re-determine a data group having relation sameness or similarity with the detected information of the some users.

According to various embodiments, the data processing module may separate one of the data groups into two or more data groups. According to an embodiment, the data processing module may separate and configure a separate data group based on information of some users representing an activation degree that is equal to or greater than a designated numerical value, included in one of the data groups.

According to various embodiments, the data processing module may configure one data group using a portion of two or more data groups having the relation similarity of a designated numerical value or more. According to various embodiments, the data processing module may connect information of remaining users of the one data group based on one user profile having an activation degree that is higher than a designated numerical value in the one data group.

A terminology “module” used for various embodiments of the present disclosure may denote, for example, a unit including a combination of one or two or more of a hardware, a software, and a firmware. A “module” may be, for example, interchangeably used with a terminology such as a unit, a logic, a logical block, a part, or a circuit, etc. A “module” may be a minimum unit of an integrally configured part or a portion thereof. A “module” may be a minimum unit that performs one or more functions or a portion thereof. A “module” may be implemented mechanically or electronically. For example, a “module” according to various embodiments of the present disclosure may include at least one of an ASIC chip, Field Programmable Gate Arrays (FPGAs), or a programmable logic device that performs certain operations, known or to be developed in the future.

According to various embodiments, at least a portion of a device (e.g., modules or functions thereof) or a method (e.g., operations) according to the present disclosure may be, for example, implemented as an instruction stored in a computer-readable storage medium in the form of a programming module. The instruction, when executed by one or more processors (e.g., the processor 811), may allow the one or more processors to perform a function corresponding to the instruction. The computer-readable storage medium may be, for example, the memory 820. At least a portion of the programming module may be, for example, implemented (e.g., executed) by the processor 811. The at least portion of the programming module may include, for example, a module, an application, a routine, an instruction set and/or a process, etc. for performing one or more functions.

A programming module according to various embodiments of the present disclosure may include at least one of the above-described elements, omit some of the elements, or further include additional other elements. Operations performed by a programming module or other elements according to various embodiments of the present disclosure may be executed sequentially, in parallel, repetitively, or in a heuristic method. Also, a portion of operations may be executed in a different sequence, omitted, or other operations may be added.

The computer-readable recording medium may include a hard disk, a magnetic medium such as a floppy disk and a magnetic tape, an optical recording medium such as a Compact Disc Read Only Memory (CD-ROM) and a DVD, a magnetic-optical medium such as a floptical disk, and a hardware device specially configured to store and perform an application instruction (e.g., a programming module) such as ROM, RAM, a flash memory, etc. Also, the application instruction may include not only a machine language code such as things generated by a complier but also a high-level language code that may be executed by a computer using an interpreter, etc. The above-described hardware device may be configured to operate as one or more software modules in order to perform an operation of the present disclosure, and vice versa.

Various aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), CD-ROMs, magnetic tapes, floppy disks, and optical data storage devices. The non-transitory computer readable recording medium can also be distributed over network coupled computer systems so that the computer readable code is stored and executed in a distributed fashion. Also, functional programs, code, and code segments for accomplishing the present disclosure can be easily construed by programmers skilled in the art to which the present disclosure pertains.

At this point it should be noted that various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method performed by an electronic device, the method comprising:
confirming, by the electronic device, two or more data groups having a group relation similarity, the two or more data groups being confirmed from a plurality of data groups each comprising information of one or more users;
transmitting the confirmed two or more data groups to another electronic device; and
deleting the two or more data groups transmitted to the other electronic device from the electronic device.

2. The method of claim 1, wherein, for each data group of the plurality of data groups, the electronic device performs:
obtaining information of a plurality of users;
obtaining one or more consumption information included in each of the information of the plurality of users;
determining relation similarity of the information of the users based on the one or more consumption information; and
when the information of the users has the relation similarity, storing the information of the users in a same data group to generate the data group.

3. The method of claim 2, further comprising:
under a circumstance where a plurality of data groups comprising a first group, which is the same data group, exists, transmitting a second group having the group relation similarity with the first group together with the first group.

4. The method of claim 2, wherein the consumption information comprises one or more of a user's favorite music information included in user information, a user's tendency information, information regarding a shooting position or a person photographed together in a case of including image data, a user's social network service information, game information, activity information for a social network inside a game, contact information for one or more other users that is connectable with a user, and electronic mail address information.

5. The method of claim 2, wherein each of the plurality of data groups comprises information of some users having the relation similarity based on information of one user having an activation degree that is higher than a designated numerical value.

6. The method of claim 2, wherein one or more data groups having the relation similarity with the same data group are included in a same database device.

7. The method of claim 2, wherein two or more data groups having the relation similarity share data.

8. The method of claim 2, further comprising:
detecting information of some users of information of the users changes by a designated ratio or more; and
re-determining a data group having relation sameness or similarity with the detected information of the some users.

9. The method of claim 2, wherein one of the data groups is separated into two or more data groups.

10. The method of claim 9, wherein the separation of the one of the data groups configures a separate data group based on information of some users representing an activation degree that is equal to or greater than a designated numerical value, included in one of the data groups.

11. The method of claim 2, wherein one data group is configured using a portion of two or more data groups having the relation similarity of a designated numerical value or more.

12. The method of claim 11, wherein the one data group connects information of remaining users of the one data group based on one user profile having an activation degree that is higher than a designated numerical value.

13. An electronic device comprising:
a communication interface configured to communicate with another electronic device;
a memory comprising information of one or more users; and
a processor configured to:
confirm two or more data groups having a group relation similarity, the two or more groups being confirmed from a plurality of data groups each comprising the information of the one or more users;
transmit the confirmed two or more data groups to the other electronic device; and
delete the two or more data groups transmitted to the other electronic device from the electronic device.

14. The electronic device of claim 13, wherein the processor is further configured to obtain information of a plurality of users with respect to each of the plurality of data groups, to obtain one or more consumption information included in each of the information of the plurality of users, to determine relation similarity of the information of the users based on the one or more consumption information, and to, when the information of the users has the relation similarity, store the information of the users in a same data group to generate the data group.

15. The electronic device of claim 14, wherein under a circumstance where a plurality of data groups comprising a first group, which is the same data group, exists, the processor is further configured to transmit a second group having the group relation similarity with the first group together with the first group.

16. The electronic device of claim 14, wherein the processor is further configured to allow the consumption information to comprise one or more of a user's favorite music information included in user information, a user's tendency information, information regarding a shooting position or a person photographed together in a case of including image data, a user's social network service information, game information, activity information for a social network inside a game, contact information for one or more other users that is connectable with a user, and electronic mail address information.

17. The electronic device of claim 14, wherein the processor is further configured to configure each of the plurality of data groups to include information of some users having the relation similarity based on information of one user having an activation degree that is higher than a designated numerical value.

18. The electronic device of claim 14, wherein the processor is further configured to allow one or more data groups having the relation similarity with the same data group to be included in a same database device.

19. The electronic device of claim 14, wherein the processor is further configured to control two or more data groups having the relation similarity to share data.

20. The electronic device of claim 14, wherein the processor is further configured to detect information of some users of information of the users changes by a designated ratio or more, and to re-determine a data group having relation sameness or similarity with the detected information of the some users.

21. The electronic device of claim 14, wherein the processor is further configured to separate one of the data groups into two or more data groups.

22. The electronic device of claim 21, wherein the processor is further configured to separate and configure a separate data group based on information of some users representing an activation degree that is equal to or greater than a designated numerical value, included in one of the data groups.

23. The electronic device of claim 14, wherein the processor is further configured to configure one data group using a portion of two or more data groups having the relation similarity of a designated numerical value or more.

24. The electronic device of claim 23, wherein the processor is further configured to connect, in the one data group, information of remaining users of the one data group based on one user profile having an activation degree that is higher than a designated numerical value in the one data group.

25. A non-transitory computer-readable storage medium storing instructions that, when executed, cause at least one processor to perform a method comprising:
confirming two or more data groups having a group relation similarity, the two or more data groups being confirmed from a plurality of data groups each comprising information of one or more users; and
transmitting the confirmed two or more data groups to another electronic device, and deleting the two or more data groups transmitted to the other electronic device from the electronic device.
